(19) United States
(12) Patent Application Publication
(10) Pub. No.: US 2008/0124134 A1
(43) Pub. Date: May 29, 2008

(54) Toner supplying device and method to use the same

(76) Inventors: Dirk Costrop, Duffel (BE); Jan Bongaerts, Mortsel (BE); Karlien Torfs, Boechout (BE); Lode Deprez, Wachtebeke (BE)

Correspondence Address: BACON & THOMAS, PLLC, 625 SLATERS LANE, FOURTH FLOOR, ALEXANDRIA, VA, 22314, US

(21) Appl. No.: 11/984,246

(22) Filed: Nov. 15, 2007

(30) Foreign Application Priority Data
Nov. 16, 2006 (EP) EP 06023796.3

(51) Int. Cl. G03G 15/08

(52) U.S. Cl. 399/263

(57) ABSTRACT

A toner particles supplying device includes a pneumatic conveyor and a rotatable container or a container with a rotatable inner structure including machinery for tumbling the toner particles. The machinery for tumbling the toner particles is located on or near an inner surface of the container and serves for fluidising toner particles and urging them toward the pneumatic conveyor.

### FIELD OF INVENTION

The present invention is broadly concerned with a toner particle supplying device and with a method for using the same. In particular, the present invention relates to a device for fluidising and pneumatically transporting toner from a container to a toner consuming device, e.g. to the dosing unit of a copier, faxmachine or printer, such as a developer station of an electrostatographic device. Devices according to embodiments of the present invention are monochrome or multi-colour electrostatographic devices that utilize dry powder toners as marking materials and comprise direct electrostatographic devices as well as devices that comprise one or more toner development steps in which one or more electrostatic latent images are developed with dry toners. The devices of the present invention are particularly suited for print production environment where printing speeds exceeds 100 pages per minute.

### BACKGROUND OF THE INVENTION

In electrophotographic printers, fax and copiers, a latent charge image is generated on a light-sensitive photoconductor material, a photoconductor drum or a photoconductor band upon light exposure, e.g. by LED or laser. This image is subsequently inked or developed with a charged toner in the developer station of the toner consuming device, e.g. printer, fax or copier. The toner image is subsequently transferred in one (direct) step or two steps (indirect) through an intermediate substrate or surface (such as a belt) to the final substrate material and (trans)fused.

A one-component or a two-component developer can be used to develop the latent charge image on the photoconductor. The one-component developer comprises only toner particles. The two-component developer comprises a mixture of toner particles and carrier particles. In the two-component developer, the toner particles are electrically charged through movements of each component relatively to the other (e.g. triboelectric charging) while in the one-component developer, the charging of the toner particles occurs via charge transfer, for example from a carrier roller or a charging doctor blade. In order to generate a toner image, a certain quantity of toner must be supplied to the developer station where toner will be used and therefore consumed. The toner supply is usually done via transfer to a dosing unit which will deliver the toner on-demand to the developer station.

In known printers, faxes or copiers, toner material is either transported from (interchangeable) toner reservoirs through an opening directly into the dosing unit, or conveyed into the dosing unit via a transport system from a separately arranged container. Generally the dosing unit near the developer station has a level sensor. When the filling level falls below a predetermined level, toner material must be supplied to the dosing unit from the container or reservoir. This occurs, for example, by emptying a toner reservoir directly into the dosing unit. In other known arrangements, a sealed reservoir filled with toner material and in the form of bottles or cartridges is adapted to be connectable to an opening in the dosing unit. The toner is released by opening the bottle or cartridge.

It is of major importance that care should be taken, during the switching of (empty) toner reservoirs (e.g. bottles) in order to ensure that the operator and the environment are well protected against any form of dust formation. This will become increasingly true in the near future when smaller toner particles with sizes down to 5 micron are going to be used. There is a trend in the toner industry to decrease the size of the toner particles because smaller toner particles lead to a lower toner consumption. The settling time for smaller particles is much larger then that of larger particles. This leads to an increased risk of inhaling these particles because the smaller the particles are, the lower the filtering efficiency of the human system is. There is a constant need of improved ways to introduce new toner into the machine.

A low weight and a small structural size of the reservoirs (e.g. bottles or cartridges) in fact enables a simple manipulation and a safe handling upon refilling of the temporary storage. However, the current trend of increasing printing speeds and increasing toner usage due to image content leads to an increase in the rate of toner consumption and more frequent refilling of the reservoir.

At the current rate, the operator of an industrial printer has to add toner to a dosing unit around once every 4 hours. With increasing operating speeds, the number of operator interventions increases. Table 1 lists toner consumption for different operating speeds and print coverage for a representative printer.

TABLE 1
Toner consumption

| | Toner consumption (mg/s) with different | | | | |
|---|---|---|---|---|---|
| | operating printer speeds | | | | |
| Coverage | 16 cm/s | 25 cm/s | 50 cm/s | 75 cm/s | 100 cm/s |
| 15% | 72 | 101 | 135 | 180 | 288 |
| 25% | 96 | 135 | 180 | 240 | 384 |
| 50% | 240 | 338 | 450 | 600 | 960 |
| 75% | 360 | 506 | 675 | 900 | 1440 |
| 100% | 480 | 675 | 900 | 1200 | 1920 |

This high toner consumption is traditionally met by adding toner via toner reservoirs (e.g. bottles). In the case of toner bottles of 800 grams an operator has to add toner at a frequency shown in table 2. At speeds of 50 cm/s and a coverage of 25% an operator has to add toner to one station every 74 minutes. An industrial printer has at least 4 stations and the operator has therefore to add toner at least every 18.5 minutes. With new designs of printer the number of stations is still increasing which will make the situation worse.

TABLE 2
Time between refill

| | Time between refill (min) with different | | | | |
|---|---|---|---|---|---|
| | operating printer speeds | | | | |
| Coverage | 16 cm/s | 25 cm/s | 50 cm/s | 75 cm/s | 100 cm/s |
| 15% | 185.2 | 131.7 | 98.8 | 74.1 | 46.3 |
| 25% | 138.9 | 98.8 | 74.1 | 55.6 | 34.7 |
| 50% | 55.6 | 39.5 | 29.6 | 22.2 | 13.9 |
| 75% | 37 | 26.3 | 19.8 | 14.8 | 9.3 |
| 100% | 27.8 | 19.8 | 14.8 | 11.1 | 6.9 |

It seems preferable that an operator adds toner only once per machine in each shift and that it should not take more time than 10 minutes for each colour. In order to do this, a printer needs large toner containers. These large containers must be adapted to be filled easily and cannot therefore be situated directly at the developer stations of the printer. A transport system is needed in order to transport toner from a large reservoir to a developer station of a printer. Safety should be high and dust release low with this toner transport.

A transport system where boxes are automatically shuttled between a storage container and the dosing unit of the printer is not an option, although this type of system is very soft for the toner. The problem with this sort of systems is that the toner dust is very difficult or impossible to control

Some transport systems can damage toner particles. Due to the mechanical forces generated in those systems, e.g. friction and impact forces, pieces of the brittle toner particles can be broken. These fine particles can then cause several problems during developing because these small particles tend to accumulate in the developer station creating depositions onto the carrier surface. Another problem that can occur during the transport is that the state of the very important toner surface additives can be altered due to collisions between the toner particles, or even come loose from the surface. This causes several problems during the development because toner charging is dependent on the presence and state of the surface additives. Examples of transport systems that could damage the toner are systems where the toner is fluidised with high rotating speeds. Fluidisation is often required because when toner particles are placed in a recipient, the toner becomes compact after a few hours. This compact toner cannot for instance be transported by air or by vacuum.

In U.S. Pat. No. 4,990,964 and U.S. Pat. No. 5,074,342, a toner material is transported with the aid of suction air from a toner reservoir into temporary storage via a tube. A vertically displaceable suction spout is immersed through an opening arranged in the top of the toner reservoir and sucks toner material out. The sloping walls of the toner reservoir and a vibrating unit provide for a nearly complete emptying of the reservoir. The suction tube is removed from the reservoir when the reservoir must be changed. The opening in the toner reservoir is always arranged on top, whereby a spillage of toner is prevented. However, in this system, the conveying capacity can be dependent on the fill state in the toner reservoir. If the conveying capacity decreases with a reduction of the fill level, the printing must be interrupted due to the lack of toner. The vibrating unit can also cause disturbing noises. The toner in this container is mainly fluidised by a small air stream at the level of the suction nozzle. In such systems, the air stream is not able to achieve an appropriate and well controlled transport density and a part of the air leaves the container creating dust. Additionally, the toner is not fluidised in the whole bottle. Especially after a period of inactivity, the chance of blockages in the conveying paths increases, when the toner density reaches a too high level.

An apparatus to convey toner material from a container by means of a suction and pressure unit that protrudes into the toner container is also known from U.S. Pat. No. 5,915,154. In this patent, toner material is sucked into the air stream resulting in a powder-gas mixture. However, a problem with this known device is that the conveying capacity can also decrease with decreasing fill level in the reservoir, leading to a possible interruption of the print process as a consequence of an insufficient toner material delivery. In this patent, air separators are used to separate air and toner. A high ratio of air/toner is used (9:1). For a non-magnetic colour toner the normal density is 0.5 to 0.6 g/cm³. A mixture of air and toner of 9:1 is therefore equivalent to a toner density of 0.05 to 0.06 g/cm³. After transport, the toner and the air have to be separated by air separators. Most systems work with a filter system to extract the toner from the air. The high ratio of toner/air used requires long suction times to handle a large volume of toner. Relatively large filters such as bulky cyclones are needed for separating such an amount of air/toner. The low densities lead also to relatively high transporting speeds. High transporting speeds can lead to fragmentation and/or abrasion of the toner particles and/or additives. At the same time the mechanical attrition and abrasion of the conveying pipe walls is proportional to the conveying speed to the power of 3 (or even 4) and is thus much increased by transporting toner at such high speeds. Higher operating speeds give rise also to a higher energy consumption.

An apparatus for transporting toner by means of vacuum is known from US2005/0254861. In this patent application, toner is conveyed by adding it to a conveying pipe via a paddle wheel. In the conveying pipe the toner is transported by reduced pressure to the developer station of the printer. The toner is delivered to the stream in a non-fluidised state. This may lead to problems of bridge formation in the storage container, because of the high density of the toner. Additionally, very large mechanical forces are present at the edges of the paddle wheel with the possible consequence of toner damage.

In Patent application US2005/0244193 a conveying system is disclosed where toner is fluidised by air nozzles and transported to the printer/copier. For a good transport of toner this patent application states that the bulk density of the toner is preferably adjusted between 0.2 and 0.3 g/cm³. The use of densities below 0.3 is inconvenient due to the need for large filters. This can be a major drawback since often very limited free space is available in the vicinity of the development station. Additionally, within this density range, more air than toner is transported, which is not very economical.

A rotating disposable toner cartridge is disclosed in patents U.S. Pat. No. 5,495,323, U.S. Pat. No. 5,852,760 and U.S. Pat. No. 4,744,493. In these patents, a cylindrical cartridge with a spiral rib on the internal periphery of the container is disclosed for urging the toner towards the end of the container. These systems are not meant to fluidise the toner since they do not rely on pneumatic conveyance. Additionally, these systems have the drawbacks that these dedicated profiled bottles are relatively expensive and must be replaced by new bottles once empty. Also 50% of the transported volume is air.

### SUMMARY OF THE INVENTION

An object of the present invention is to provide an improved method and apparatus for conveying toner particles to an electrostatographic device such as but not limited to an electrophotographic device. An advantage of the present invention is that it permits to transport efficiently toner of limited fluidity over a distance. This allows to separate a large capacity toner supply from the specific location where the toner is needed in the functional printing process. Another advantage of the present invention is that the toner particles are not damaged substantially during transport. Another advantage is that the transport of toner particles is done in dust-free manner from a container to a recipient vessel. Another advantage is that the toner transporting device and method have a conveying capacity that is substantially independent of the fill state of the reservoir. Another advantage of a toner transporting device and method according to the present invention is that there is no need for bulky air separators. Also blockages and obstructions of the conveying path can be avoided or reduced.

Broadly speaking, the invention is based on the unexpected finding that the toner must have a minimum degree of fluidity in order to be transported efficiently. This fluidity can be induced by bringing a controlled amount of air into a moving toner system.

The invention is also based on the unexpected finding that particle shape, i.e. circularity, and particle size are two parameters from which the maximum transport density of the toner, i.e. the maximum density allowing vacuum or air mediated transportation, can be determined provided that the bulk density of the toner is known.

In a first embodiment, the present invention relates to a method for supplying toner particles from a container to a recipient vessel comprising conveying pneumatically at least part of the toner particles to the recipient vessel, wherein the toner particles are fluidised in the container to a bulk density between 0.30 g/cm³ and

$${D}_{c} - \frac{( 1000 C - 900 )}{Dv 50} \times \frac{{10}^{- 6} g}{{cm}^{2}}$$

before the conveying, wherein D_{c} is the collapsed bulk density of the toner particles, C is the circularity of the toner particles and Dv50 is the 50% volume average particle diameter. Optionally the toner particles may be fluidised in the container to a bulk density between 0.35 g/cm³ and

$${D}_{c} - \frac{( 1000 C - 900 )}{Dv 50} \times \frac{{10}^{- 6} g}{{cm}^{2}}$$

before the conveying.

The bulk density refers to the weight of toner particles in the volume that this weight of toner particles occupies during the process of fluidising in the container. The more the toner particles are fluidised the lower the bulk density. Preferably, the container is rotatable or a structure comprised inside the container is rotatable. Preferably, the container or an inner structure thereof has stir vanes located on or near to the inner surface of the container, e.g. in a spiral or helical form. A fluidisation of toner particles within the range prescribed in this first embodiment is advantageous because it correspond to a range of densities providing 1) enough fluidity for the toner to be transported efficiently via a pneumatic conveyor without forming plugs or aggregates in the conveying system and 2) enough density to be economical and to be compatible with relatively small toner separators and filters.

As an optional feature, the recipient may be the dosing unit of an electrostatographic device such as a printer, faxmachine or copier, e.g. an electrophotographic printer, fax or copier. The method then comprises dosing the toner particles from the recipient vessel to an electrostatographic device.

As another optional feature, the toner particles may be conveyed batchwise to the recipient. This is advantageous because it results in less load on the air separator or filter and because it permits good control of the amount of toner transported.

As another optional feature, the pneumatic conveyance includes at least an air suction action and an air blowing action, preferably alternating. This is advantageous because it permits cleaning of the filter after each toner conveyance event and counteracts the vacuum to facilitate conveying the toner further on.

As another optional feature an extra air inlet can be placed after the container to permit cleaning of the conveying system after each conveyance event and to facilitate toner transport especially in pneumatic transport over a long distance.

As another optional feature, at least part of the fluidised toner particles may be delivered to an intermediate recipient such as a scoop prior to being conveyed pneumatically to the recipient vessel. This is advantageous because it provides one way to transport the toner particles batchwise.

As another optional feature, the intermediate recipient can be tilted at any angle between 0° and 180°. This is advantageous because it permits to control the amount of toner that will form one batch and that will be transported. For some angles (e.g. 180°), it also prevents toner to enter into the intermediate recipient and it therefore allows the toner to tumble an extra amount of time before being conveyed.

As another optional feature, in the case of batchwise toner particle transport, the conveyance may involve at least a suction action that lasts as long as necessary or longer than necessary for the conveyance of a batch of toner. A suction action lasting longer than necessary for the conveyance is advantageous because it cleans the conveyor and prevents any blockage of toner in the conveyor tube.

As another optional feature, the toner particles may be provided to a printer of the electrostatographic type utilizing dry toner as marking materials. Such printers comprise direct electrostatographic devices as well as devices that comprise one or more development steps in which one or more electrostatic latent images are developed with dry toners. Intended devices comprise monochrome devices as well as multi-colour devices. An example of device that benefit from the present embodiment is a device for use in a print production environment. Preferably, such a device has a printing speed exceeding 100 pages per minute.

In a second embodiment, the present invention relates to a toner particles supplying device comprising:
a rotatable container or a container comprising a rotatable inner structure. The rotatable inner structure comprises means for tumbling the toner particles located on or near an inner surface of the container for fluidising toner particles and urging them toward a pneumatic conveyor, and
a pneumatic conveyor.

As an optional feature the means for tumbling the toner particles are stir vanes.

The stir vanes are preferably adapted to cause tumbling of the toner when the rotatable container or inner structure is rotated. The stir vanes may be arranged in helical or spiral form so that there is not only tumbling of the toner particles but also a general transport in the direction of the toner outlet. The container or its inner structure is preferably arranged to rotate about an horizontal axis or a slightly tilted axis where the tilt angle is less than 30 degrees, e.g. has means for fixing in a faxmachine, printer or copier such that its rotational axis is horizontal or slightly tilted where the tilt angle is less than 30 degrees. The container can be cylindrical or conical in shape.

As an optional feature, rotating blades can be provided at the toner inlet of the container. These rotating blades that are part of the container or its inner structure allow a filling level higher than the container mid section.

As another optional feature, the stir vanes merge into, change into or are replaced by paddles at the outlet of the container. This is advantageous because the paddles permit to fill in with toner an intermediate recipient which capacity and tilt define a batch of toner.

As another optional feature, the container may further comprise an intermediate recipient situated relatively to the paddles so that said paddles can deliver toner particles into said intermediate recipient. This is advantageous because it permits the batchwise transport of toner.

As an optional feature the intermediate recipient (e.g. the scoop) can be rotated independently from the rotatable container or inner structure. By a rotation, toner material that may have compacted during a period in which no transport was needed can be emptied from the intermediate recipient back into the container, allowing a later replenishment of the intermediate recipient with properly fluidized toner. The tilt or rotation angle of the intermediate recipient also serves to tune the amount of toner that will be collected in this intermediate recipient. The intermediate recipient can be tilted between a toner receiving position and a non-receiving position.

As another optional feature, the rotatable container or inner structure may be adapted to fluidise the toner particles to a bulk density between 0.30 g/cm³ and

$${D}_{c} - \frac{( 1000 C - 900 )}{Dv 50} \times \frac{{10}^{- 6} g}{{cm}^{2}}$$

before said conveying, wherein D_{c} is the collapsed bulk density of the toner particles, C is the circularity of the toner particles and Dv50 is the 50% volume average particle diameter.

Optionally, the rotatable container or inner structure may be adapted to fluidise the toner particles to a bulk density between 0.35 g/cm³ and

$${D}_{c} - \frac{( 1000 C - 900 )}{Dv 50} \times \frac{{10}^{- 6} g}{{cm}^{2}}$$

before said conveying.

In a third embodiment, the present invention relates to a toner consuming device such as printer, a fax machine or a copier of the electrostatographic type utilizing dry toner as marking materials comprising a toner particles supplying device as disclosed in the second embodiment or in any of its optional features described above. Such toner consuming devices comprises direct electrostatographic devices as well as devices that comprise one or more development steps in which one or more electrostatic latent images are developed with dry toners. Intended devices comprise monochrome devices as well as multi-colour devices. The device is preferably usable in a print production environment. Preferably, the device enables printing speeds exceeding 100 pages per minute,

### BRIEF DESCRIPTION OF THE DRAWINGS

FIG. 1 is a schematic representation of a toner supplying device according to an embodiment of the present invention.

FIG. 2 is a schematic view of the rotatable inner structure of a container according to an embodiment of the present invention.

FIG. 3 is a schematic view of the rotatable inner structure of a container according to an embodiment of the present invention.

FIG. 4 is a schematic lateral view of the rotatable inner structure of a container according to an embodiment of the present invention.

### DETAILED DESCRIPTION OF THE ILLUSTRATIVE EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term <<comprising>> is used in the present description and/or claims, it does not exclude the presence of other elements or steps.

Where an indefinite article is used when referring to a singular noun e.g. <<a>>, <<an >> or <<the >>, this includes a plural of that noun unless something else is specifically stated.

Furthermore, the terms first, second, third and the like in the description and/or in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In a first embodiment, the present invention relates to a method for supplying toner particles from a container to a recipient comprising conveying pneumatically at least part of said toner particles to said recipient.

The toner particles that can be conveyed by the present invention can be of any nature or shape and can be associated or not with carrier particles. Hence they may be two components or one component toner particles. The toner particles may comprise any material customary in toners such as binder materials, charge control agents, pigments, fillers, charge and flow additives among others. The binder materials can be of polymeric nature and may comprise for instance polystyrene or polymers of styrene derivatives, polyvinylchloride, polyvinylacetate, polyethylene, polypropylene, polyester, cyclic olefin copolymers, epoxy resin, epoxypolyol resin, polyurethane, polyamide, polyvinylbutyral, polyacrylic resin, modified resin, terpene resin, aliphatic or aromatic petroleum resin, chlorinated paraffin or paraffin wax among others, or a combination of such materials.

The toner particles can be prepared by any suitable method, e.g. chemically and/or mechanically. They can either be used as such or they can be processed to improve their properties, e.g. their circularity. For example, they can be rounded thermally or mechanically to improve the development qualities of the toner.

The container serves as a temporary storage of toner wherein the toner is fluidised before to be transported to the recipient. The container is preferably cylindrical and can be rotatable. Alternatively, the container is fixed and its inner structure is rotatable. The rotation axis of the container or inner structure is preferably horizontal, but can be inclined as well. Preferably, the rotation speed can be adjusted. For this purpose a drive means for the container/inner structure and a controller can be provided. The container preferably has an inlet and an outlet. The inlet allows toner refill and the outlet allows transport of the toner to the pneumatic conveyor. The inlet and outlet are preferably positioned along the rotation axis of the container/inner structure. The container/inner structure can be made of any material but will preferably be made of conductive plastic or metal. The container preferably has means on the inner surface for promoting tumbling of the toner when the container is rotated. Alternatively, it is a rotatable inner structure of a fixed container that has means for promoting tumbling of the toner when the inner structure is rotated. The tumbling means can be stir vanes located on or near the inner surface of the container. If it is the container which is rotated, the stir vanes are preferably located on the inner surface of the container. If it is an inner structure of the container which is rotated, the stir vanes are preferably not in contact with the inner surface of the container (to avoid wearing of the stir vanes and the container) but are near the inner surface, i.e. not farther apart than 10 mm from de inner surface, preferentially not farther apart than 6 mm from the inner surface. The stir vanes may be arranged in helical or spiral form so that there is not only tumbling of the toner particles but also a general transport in the direction of the toner outlet. The stir vanes urge or force the toner to tumble and prevent or reduce the tendency of the toner to slide circumferentially. Accordingly 1) abrasion of the inside of the container is reduced and 2) deterioration of the toner or break up thereof into fines is reduced or prevented. By the position of the stir vanes in the container/inner structure, the toner is urged or forced toward the outlet, thereby creating a natural flow through the container so that toner stays a limited time within the container. The stir vanes enable therefore a complete discharge of the container without leaving any dead volumes of toner in it.

The stir vanes are replaced by, change into or merge into paddles, at the outlet side of the container. The paddles may by aligned along the direction of the rotational axis of the container. The function of these paddles is to scoop the toner into an intermediate recipient located at the outlet of the container. The intermediate recipient does not rotate together with the container/inner structure. The volume and the tilt of the intermediate recipient determines the amount of toner that will be transported to the recipient. The intermediate recipient can be tilted between 0 and 180°. When tilted 180°, no toner enters the intermediate recipient and any toner in the intermediate recipient is released back into the container. This can be useful if the desired toner density is not yet reached since it allows the toner to tumble an extra amount of time before being conveyed.

The tilting is preferably a rotation movement around the same rotational axis as the container/inner structure.

The system is advantageous because it provides a means to scoop into the intermediate recipient and therefore to transport toward the pneumatic conveying system an equal amount of toner independently of the filling state of the container. The intermittent (i.e. batchwise) delivery of a precisely defined amounts of toner, as enabled by the present embodiment, permits the conveyor unit to blow or suck air longer than required for the transport of the desired amount of toner (i.e. one batch) without transporting more than the desired amount of toner.

The density of the toner achieved in the container prior conveyance is of crucial importance. 0.30 g/cm³ is a minimum value because below this value the toner/air mixture comprises more air than toner.

The apparatus and method of the present invention are adapted so that the transport density is preferably higher than 0.30 g/cm³, i.e. it is preferable to transport more toner than air. Small toner densities require the use of large filters or even cyclones when the density drops below 0.05 g/cm³. The size available for a filtering device in the development chamber being very limited, a toner density above 0.30 g/cm³, optionally above 0.35 g/m³, is highly preferred.

The bilk density of a toner particle air mixture is the weight of toner within a volume of air. The more the toner particles are fluidised the lower the bulk density.

Preferably, the density of the toner is homogeneous in the bulk. In the present invention, the density of the toner is decreased in the container. The container changes the density of the toner without blowing an excess amount of air into it. It uses, for example, only the amount of air originally present in the container. Upon rotation, the container or its inner structure increases the fluidity of the toner (reduces the density) up to a maximum value (minimum value if density) fixed by the geometry of the container/inner structure. This maximum can be varied by changing the size and form of the stir vanes and by changing the rotating speed of the container/inner structure. This mixing process introduces only a limited amount of energy into the toner and is therefore particularly toner friendly. The present invention results from the unexpected finding that the minimum density at which a toner becomes transportable (Dₜᵣₐₙₛₚₒᵣₜ) can be determined by measuring only two physical properties of the toner particles and the collapsed bulk density (D_{c}) of the toner. In the present embodiment, the aim of this fluidisation is therefore to bring the density of the toner between 0.30 g/cm³ and Dₜᵣₐₙₛₚₒᵣₜ, preferably between 0.35 g/cm³ and Dₜᵣₐₙₛₚₒᵣₜ, more preferably between (Dₜᵣₐₙₛₚₒᵣₜ−25%) and Dₜᵣₐₙₛₚₒᵣₜ, yet more preferably between (Dₜᵣₐₙₛₚₒᵣₜ−15%) and Dₜᵣₐₙₛₚₒᵣₜ and most preferably between (Dₜᵣₐₙₛₚₒᵣₜ−10%) and Dₜᵣₐₙₛₚₒᵣₜ. Dₜᵣₐₙₛₚₒᵣₜ is defined by the following equation (eq. 1):

$${D}_{c} - {D}_{transport} \geq \frac{( 1000 C - 900 )}{Dv 50} \times \frac{{10}^{- 6} g}{{cm}^{2}} , \qquad ( eq . 1 )$$

Where D_{c} is the collapsed bulk density of the toner (in g/cm³), Dₜᵣₐₙₛₚₒᵣₜ is the transport density of the toner (in g/cm³), C is the circularity of the toner particles (dimensionless) and Dv50 is the 50% volume average particle diameter (in cm).

C is a parameter which indicates the roundness of a particle. When C is 1 the particle is a perfect sphere. Toner particles have typically C values comprised between 0.90 and 0.97.

C is a value obtained by optically detecting toner particles, and is the circumference of the area equivalent circle (i.e. the circle that has the same area as the in-plane projected particle image) divided by the perimeter of the in-plane projected particle image. For instance, the average circularity of the toner can be measured using a flow particle image analyser of the type FPIA-2000 or FPIA-3000 manufactured by Sysmex corp.

Dv50 is the average particle diameter for which 50% in volume of the particles have a diameter which is smaller than Dv50. This diameter can be measured for instance with a COULTER COUNTER MULTISIZER particle size analyser. D_{c} is the collapsed bulk density of the toner. D_{c} is measured as follow: 100 grams of toner is tapped 1000 times with a JEL Stampfvolumeter model STAV2003 and the collapsed density of the toner is calculated from the volume after 1000 taps.

The adaptation of the rotatable container or inner structure is done by optimisation of the stir vanes and the paddles. The rotation speed of the container is used for a given geometry to control the fluidisation. Another controllable parameter is the delay between the filling of the intermediate recipient and the start of the actual vacuum transport.

The fluidisation is performed by rotating the partially filled container or its inner structure. Depending on the initial fluidity (density) of the toner, the toner particles start to slide at an angle between 20° and 70°. This creates an avalanche and brings air into the toner. By further rotating the container/inner structure, tumbling will be initiated and the amount of air will increase in the toner until a maximum is reached.

If the container/inner structure stops rotating, the air will slowly vent out of the toner causing the toner to settle and the density to rise. By continuously revolving the container/inner structure, air is maintained captive into the toner. The geometry of the container is preferably adapted to the particular toner type in use.

Another advantage of the present embodiment, is that this principle will work independently of the filling level of the container and of the collapsed state of the toner. A toner stocked since a year will be fluidised just as well as a toner already partially fluidised.

The container can be filled with toner from simple and commonly used packaging made of polymers, such as but not limited to polyethylene, polypropylene, polystyrene, or blends of such polymers, or blends of a polymer with a metallic foil. This simple packaging allow and easily reduction in volume and can be easily disposed with a minimum of waste. The content of this packaging does not longer have to contain a large amount of air, because the fluidisation occurs inside the fluidisation system.

The supply or conveyor system usable to transport toner particles from the container to a recipient vessel is preferably pneumatic, i.e. vacuum driven or air driven. The system transports the toner from the container to the recipient vessel provided with an air separator such as a filter. The standard way of providing toner to the conveyor is by means of a tangent supply tube to minimise the dust production.

The inner filter in this conveying device can be cleaned each suction-stroke by supplying a burst of blown air to break the vacuum and assure disturbance free emptying of the conveyor.

Examples of filters include but are not limited to PTFE coated fabrics, sintered metal or plastic fibres.

The function of the recipient vessel is to receive a number of charges from the conveying unit. It serves as a stirring system for the locally stored toner and as a toner feeder in function of the printer demand. The recipient vessel is preferably the temporary storage/dosing unit of a toner consuming device such as a faxmachine, copier or printer, e.g. an electrophotographic printer or copier.

The recipient vessel can be similar in structure and function to the container (i.e. a rotatable container or a fixed container with a rotatable inner structure) or it can be a fixed container with a conventional steering rod or Z blade.

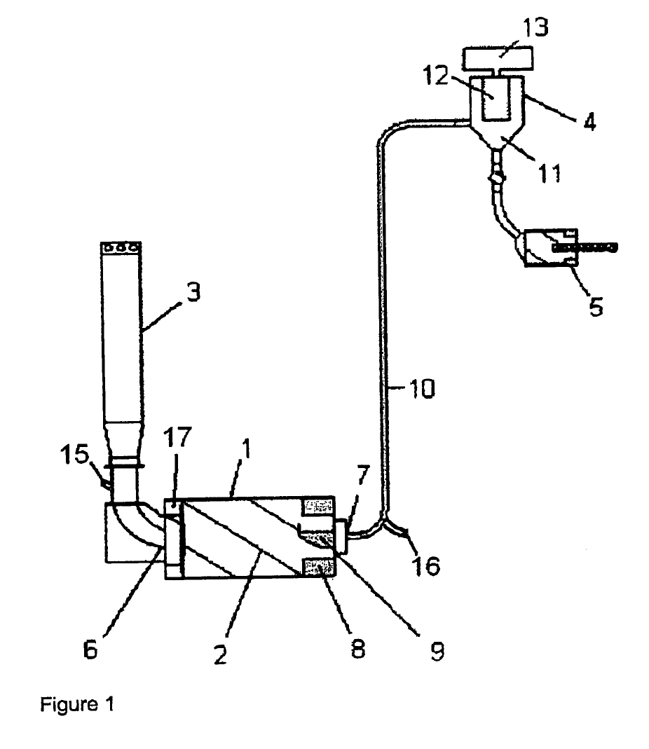

FIG. 1 illustrates schematically a toner supplying device according to a specific embodiment of the present invention. It comprises a toner storage (3) for providing toner trough an inlet (6) to a container (1) with a rotatable inner structure equipped with stir vanes (2) located near the inner surface of the container (1) for fluidising toner particles and urging them toward a pneumatic conveyor (10) via an outlet (7) for transport to a recipient vessel (5). The device is equipped with an air inlet (15). The stir vanes (2) may be arranged in helical or spiral form so that there is not only tumbling of the toner particles but also a general transport in the direction of the toner outlet (7). Preferably the container is rotated by a drive means about a horizontal axis. The container (1) further comprise blades (17), situated after inlet (6) for lifting the toner above an entrance performed in container (1). The container also comprises paddles (8) for scooping and delivering toner to the intermediate recipient (9) and therefore provide a pre-determined amount of toner to the pneumatic conveyor (10). The toner supplying device further comprises a transport system (4) for generating vacuum in the pneumatic conveyor (10). The pneumatic conveyor is optionally provided with an air inlet (16) for blowing air in the pneumatic conveyor (10). The transport system comprises a vacuum mean such as a pump (13) and a filter (12) for separating the toner and the air. The transport system (4) is further equipped with a hopper (11) for directing toner particles to a recipient vessel (5) for receiving toner from the container (1) and for dosing toner into a developer chamber (not depicted).

Preferably, the rotatable container is adapted to fluidise the toner particles to a bulk density between 0.30 g/cm³ and

$${D}_{c} - \frac{( 1000 C - 900 )}{Dv 50} \times \frac{{10}^{- 6} g}{{cm}^{2}}$$

before said conveying, or optionally between 0.35 g/cm³ and

$${D}_{c} - \frac{( 1000 C - 900 )}{Dv 50} \times \frac{{10}^{- 6} g}{{cm}^{2}}$$

before said conveying.

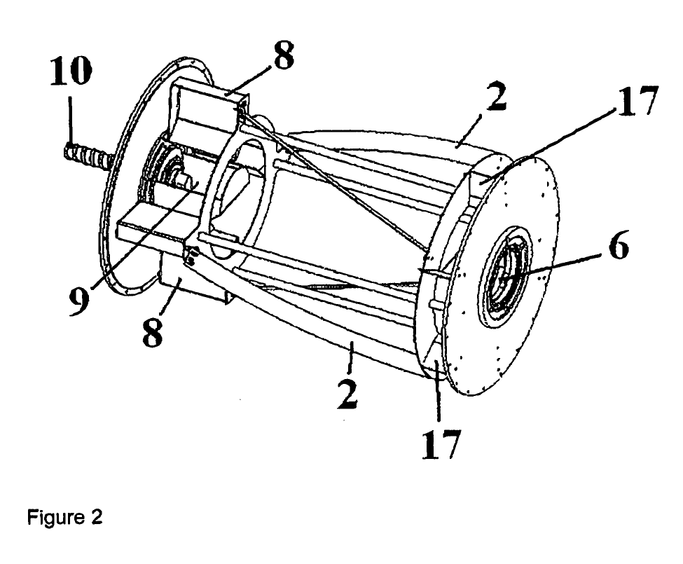

FIG. 2 represents a rotatable inner structure of a container according to a specific embodiment of the present invention. The inner structure presents an inlet (6) for the toner and blades (17) for delivering toner inside the container upon rotation of said inner structure. Stir vanes (2) for fluidizing and urging toner to the outlet of the container are depicted. Close to the outlet, the stir vanes are replaced by paddles (8) for delivering toner to the intermediate container (9) upon rotation of said inner structure. The intermediate container (9) can rotate independently from the rest of the inner structure. A pneumatic conveyor (10) in pneumatic communication with intermediate container (9) permits to transport a batch of toner contained in the intermediate container (9) to recipient vessel (5) (not depicted).

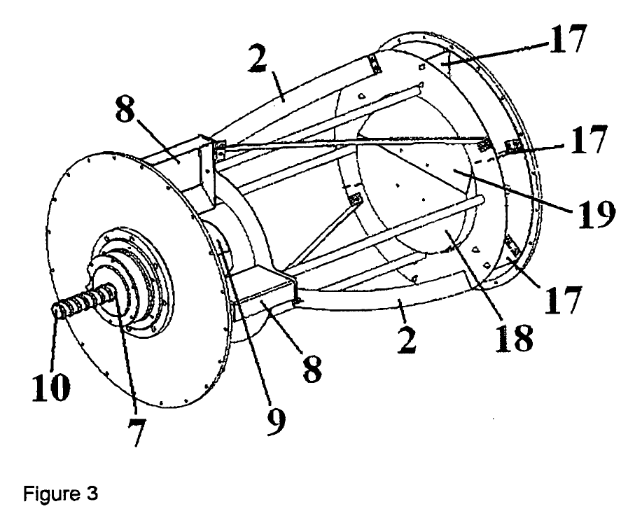

FIG. 3 represents another view of the same rotatable inner structure as represented in FIG. 2. In this view, a circular structure composed of a portion (18) perpendicular to the rotation axis of the inner structure and a portion (19) inclined toward the inlet of the container is shown. The inclined portion (19) forms an opening through which toner particles lifted by the blades (17) can fall.

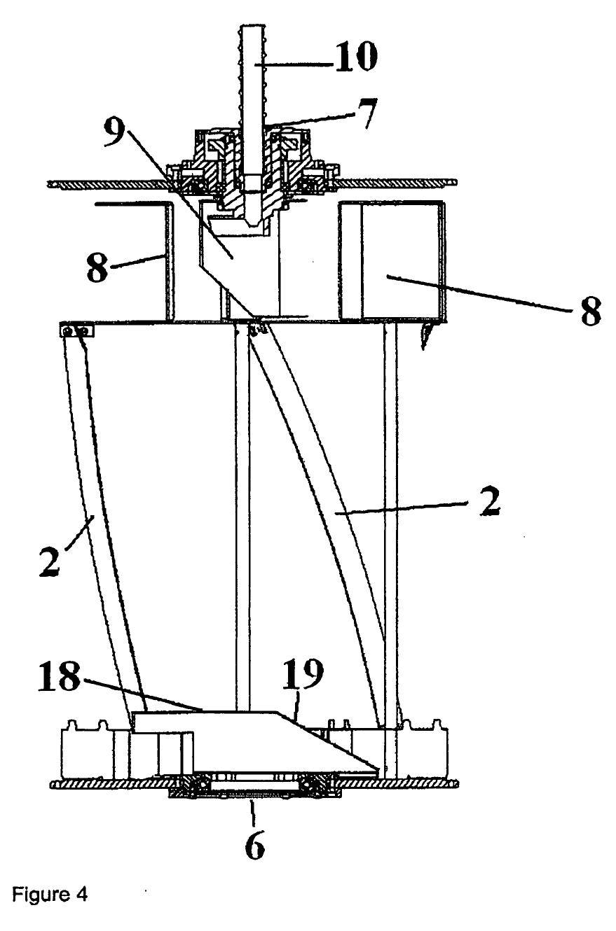

FIG. 4 represents a lateral view of the same rotatable inner structure as represented in FIG. 2 and FIG. 3. In this lateral view, the connection between the pneumatic conveyor (10) and the intermediate container (9) is clearly seen.

In a third embodiment, the present invention relates to an electrostatographic device such as a faxmachine, a copier or a printer comprising the toner particles supplying device of the second embodiment hereabove. Preferably, the electrostatographic device utilizes dry powder toners as marking materials and comprises direct electrostatographic devices as well as devices that comprise one or more toner development steps in which one or more electrostatic latent images are developed with dry toners. Intended devices comprise monochrome devices as well as multi-colour devices. Preferably, the device is useable in a print production environment, preferentially with printing speed exceeding 100 pages per minute.

### EXAMPLES

In the present examples, DV50 was measured with a Coulter counter and the circularity was measured with a Sysmex FPIA 3000 image analyzing system.

Table 3 shows the results of transport tests operated on different toners at different transport density.

TABLE 3
transport density of toner

| | | | Maximum | | | | |
|---|---|---|---|---|---|---|---|
| | Particle | | density | Final | Difference | | |
| | size | | for | collapsed | in | | |
| | (dv₅₀) | Circularity | transport | density | densities | Tranport | (Circ*1000 − 900) |
| Toner | (μm) | (Circ) | (g/cm³) | (g/cm³) | (g/cm³) | possible | (dV₅₀*100) |
| toner 1 | 8 | 0.94 | 0.27 | 0.62 | 0.35 | NOK* | 0.05 |
| | | | 0.35 | | 0.27 | OK | |
| | | | 0.57 | | 0.05 | OK | |
| | | | 0.59 | | 0.03 | NOK | |
| toner 2 | 9 | 0.95 | 0.26 | 0.55 | 0.29 | NOK* | 0.056 |
| | | | 0.31 | | 0.24 | OK | |
| | | | 0.49 | | 0.06 | OK | |
| | | | 0.51 | | 0.04 | NOK | |
| toner 3 | 9 | 0.96 | 0.29 | 0.68 | 0.39 | NOK* | 0.067 |
| | | | 0.40 | | 0.28 | OK | |
| | | | 0.53 | | 0.15 | OK | |
| | | | 0.64 | | 0.04 | NOK | |
| toner 4 | 6 | 0.96 | 0.28 | 0.61 | 0.33 | NOK* | 0.10 |
| | | | 0.37 | | 0.24 | OK | |
| | | | 0.50 | | 0.11 | OK | |
| | | | 0.55 | | 0.06 | NOK | |

The mention “OK” in the seventh column indicates that an efficient toner transport was possible.
The mention “NOK*” in the seventh column indicates an insufficient Dₜᵣₐₙₛₚₒᵣₜ, i.e. the transport is possible but is not economical and may lead to clogging of the filter.
The mention “NOK” in the seventh column indicates that the transport of toner is not possible.

As we can see in table 3, toner 1 could not be transported at a Dₜᵣₐₙₛₚₒᵣₜ of 0.59 but could be transported at a Dₜᵣₐₙₛₚₒᵣₜ of 0.57. This is consistent with the condition that the toner must be fluidised to a bulk density between 0.30 g/cm³ and

$${D}_{c} - \frac{( 1000 C - 900 )}{Dv 50} \times \frac{{10}^{- 6} g}{{cm}^{2}}$$

in order to be transportable.

The invention is by no means limited to the above-described embodiments given as an example and represented in the accompanying drawings; on the contrary, the methods according to the invention can be performed in various ways while still remaining within the scope of the invention.

1.- A method for supplying toner particles from a container to a recipient vessel comprising conveying pneumatically at least part of said toner particles to said recipient vessel, wherein the toner particles are fluidised in said container to a bulk density between 0.30 g/cm³ and
$${D}_{c} - \frac{( 1000 C - 900 )}{Dv 50} \times \frac{{10}^{- 6} g}{{cm}^{2}}$$
before said conveying, wherein D_{c} is the collapsed bulk density of the toner particles, C is the circularity of the toner particles and Dv50 is the 50% volume average particle diameter.

2.- The method of claim 1, wherein the container or an inner structure thereof is rotatable, further comprising tumbling of the toner particles when the container or an inner structure thereof is rotated.

3.- The method of claim 2, wherein the tumbling of the toner particles is carried out by stir vanes located on or near an inner surface of the container.

4.- The method of claim 1, further comprising dosing the toner particles from said recipient vessel to an electrophotographic printer, faxmachine or copier.

5.- The method of claim 1, wherein said toner particles are conveyed batchwise to said recipient vessel.

6.- The method of claim 5, wherein said pneumatic conveying includes at least a suction action or a blowing action that lasts as long as necessary or longer than necessary for the conveyance of a batch of toner particles.

7.- The method of claim 1, wherein at least part of the fluidised toner particles are delivered to an intermediate recipient prior to being conveyed pneumatically to said recipient vessel.

8.- The method claim 7, wherein said pneumatic conveying includes at least a suction action or a blowing action that lasts as long as necessary or longer than necessary for the conveyance of a batch of toner particles.

9.- The method of claim 1, wherein the toner particles are provided to a printer of the electrostatographic type using dry toner development.

10.- The method of claim 9, wherein said printer has a print speed exceeding 100 pages per minute.

11.- The method of claim 1, wherein the toner particles are fluidised in said container (1) to a bulk density between 0.35 g/cm³ and
$${D}_{c} - \frac{( 1000 C - 900 )}{Dv 50} \times \frac{{10}^{- 6} g}{{cm}^{2}}$$
before said conveying.

12.- A toner particles supplying device for use with a pneumatic conveyor comprising a container, wherein the container is rotatable container or wherein the container is provided with a rotatable inner structure with means for tumbling the toner particles located on or near an inner surface of the container for fluidising toner particles and urging them toward the pneumatic conveyor.

13.- The toner particles supplying device according to claim 12, wherein the means for tumbling the toner particles are stir vanes.

14.- The toner particles supplying device according to claim 13, wherein the stir vanes merge into or change into paddles at the outlet of said container.

15.- The toner particles supplying device according to claim 14, wherein said rotatable container or said container with a rotatable inner structure further comprises an intermediate recipient situated relatively to said paddles so that said paddles can deliver toner particles into said intermediate recipient.

16.- The toner particles supplying device according to claim 15, wherein said intermediate recipient can be tilted between a toner receiving position and a non receiving position.

17.- The toner particles supplying device according to claim 12, wherein said rotatable container or said container with a rotatable inner structure is adapted to fluidise the toner particles to a bulk density between 0.30 g/cm³ and
$${D}_{c} - \frac{( 1000 C - 900 )}{Dv 50} \times \frac{{10}^{- 6} g}{{cm}^{2}}$$
before said conveying, wherein D_{c} is the collapsed bulk density of the toner particles, C is the circularity of the toner particles and Dv50 is the 50% volume average particle diameter.

18.- The toner particles supplying device according to claim 17, wherein said rotatable container or said container with a rotatable inner structure is adapted to fluidise the toner particles to a bulk density between 0.35 g/cm³ and
$${D}_{c} - \frac{( 1000 C - 900 )}{Dv 50} \times \frac{{10}^{- 6} g}{{cm}^{2}}$$
before said conveying.

19.- A toner consuming device comprising a toner particles supplying device according to claim 12.

20.- A toner consuming device according to claim 19, wherein said toner consuming device is a printer of the electrostatographic type having a print speed exceeding 100 pages per minute.
